(19) United States
(12) Patent Application Publication
(10) Pub. No.: US 2007/0238453 A1
(43) Pub. Date: Oct. 11, 2007

(54) SYSTEM AND METHOD FOR DELIVERING NOTIFICATION THROUGH TELEPHONE NETWORK

(76) Inventor: Ting-Mao Chang, San Jose, CA (US)

Correspondence Address: TING-MAO CHANG, 2126 VILLANOVA ROAD, SAN JOSE, CA, 95130, US

(21) Appl. No.: 11/696,720

(22) Filed: Apr. 4, 2007

Related U.S. Application Data
(60) Provisional application No. 60/744,345, filed on Apr. 5, 2006.
(60) Provisional application No. 60/865,403, filed on Nov. 11, 2006.

(51) Int. Cl. H04Q 7/20

(52) U.S. Cl. 455/421

(57) ABSTRACT

A system and method for delivering notification through telephone network is provided. User registers one or more trigger condition with the notification system. The notification system assigns a phone group to each of said trigger conditions and also output the mapping relation between said trigger conditions and their phone groups to user. The notification system then call the user's phone from at least one phone in said phone group related to one of said trigger condition upon detects an event that matches with the trigger condition. A monitor system on user's phone can perform pre-selected job upon detecting incoming call from said source phone group.

### BACKGROUND

1. Field of Invention

This invention related to deliver a notification from the first computer system to the second computer system through telephone network, and, more particularly, relates to system and method for delivering notification from a computer server to a phone device. The monitor system in a phone can further be used to remind user upon calling to or receiving call from a pre-selected call party.

2. Description of Prior Art

The present invention is related to notifying a phone device one or more trigger events by using the phone network. Yahoo! Inc. provides a mobile alert service that delivers a user specified trigger event to user's mobile phone by calling user's mobile phone and delivery a short text message. Since user need to received the short text message to tell what kind of trigger event occurred, user need to pay for the communication fee charged by the phone company or the wireless carrier, even if Yahoo's service is free.

### SUMMARY OF THE INVENTION

A system and method for delivering information from a notification system operating at the host system, for example a computer server, to a destination phone group upon sensing a triggering event is provided, wherein the destination phone group includes one or more phone identities. A mapping module of the notification system associates a user's trigger condition to a source phone group automatically or with help from user, wherein the source phone group includes one or more phone identities. Said phone identity usually is a phone number, a caller ID, or a phone number with a caller's identity. For each user, the mapping module will preferably associate each of user's trigger conditions to a unique source phone group within user's trigger conditions. The mapping relation is provided to user or user's phone. Therefore, user or user's phone can distinguish the trigger event by the source phone group from which an incoming phone call. The association between a trigger condition and a source phone group might be terminated or expired according to rule of the notification system or user's preference. A notification system enables a user to send a notification from the notification system to the user's phone upon detecting that one or more user-defined triggering events have occurred. The notification system operates in connection with event generating applications at the host system to configure and detect a particular event that defined by said trigger condition, and then to notify user's phone the trigger event by calling one or more phone numbers in the related destination phone group from one or more phone numbers in the related source phone group through a telephone network. A monitor system on user's phone monitors the phone number or caller ID of the incoming phone call and performs a pre-selected job based on the phone number of the incoming phone call.

An embodiment to deliver new arrived e-mail message to user is that user requests the notification system to make a phone call to user's phone device from a phone in the source phone group when a new e-mail message or a e-mail from a pre-selected sender arrived in user's mail box, and the user schedules a job with the monitor system on user's phone device to retrieve e-mail message from an e-mail server upon sensing an incoming call from said phone number.

The notification system detects one or more trigger events for sending notice to user by making a phone call from a phone in the source phone group. For distinguish the different trigger events, the notification system assigns each of trigger events of a user a unique source phone group. The trigger event may be any events, such as user's e-mail arrival, user's e-mail arrival from a particular sender, a new meeting appointment request, severe weather warning, new lows or highs of a stock monitored by user, breaking new on an interested topic. Therefore, said event may be any event, internal, external, or network event.

The monitor system on user's phone device also provides functions for scheduling one or more system default or user specified jobs, and for execute said jobs in response to detect the incoming phone call from one or more pre-selected phone number. The job may be one or more tasks, for example displaying the information related the trigger event, exchanging e-mail with an e-mail server on another computer, sending a pre-determined message or data to another computer through a wireless network, turning on a data network connection, such as GPRS, and making a phone call to a pre-determined phone number, login to another computer system through a pre-selected authentication process, sending a set of computer instruction to control another computer, showing the phone identify plus a pre-selected message or picture, playing back a pre-selected voice/audio message or video message or ring tone, and executing a pre-selected computer program, such as calendar, e-mail viewer, web browser, etc.

In an alternative embodiment, the notification system makes the phone call to user's mobile device and disconnects the phone call before user answer the phone call for reducing the fee charged by the phone company. The condition to disconnect the phone call can be configured by user. The notification system might disconnect the phone call after waiting a number of seconds or a number of ringing received before user answer the phone call.

In another embodiment, the monitor system monitors the incoming phone call and prevents user answer the incoming phone call if the phone call is from the phone identity that related to one of scheduled jobs. To prevent user answer the incoming phone call, the monitor system will disconnect the phone call if the incoming phone call is allowed to be disconnected without answering the call. Otherwise, the monitor system can change the incoming phone call notification, i.e. ring tone or vibration. To change the incoming phone call notification is either to turn it off or to change it to another type of notification to distinguish it from normal phone call.

In yet another embodiment, the notification system on a host system makes the phone call to user's mobile device from a phone originator with a pre-selected phone identity upon receiving an Internet phone from a particular party to the user. The monitor system on user's mobile phone notifies user when received incoming call from said pre-selected phone identity. If user decides to answer the phone call, the monitor system might further bridge the communication to the Internet phone call. If user misses the phone call, the monitor system might call another pre-selected phone number associated with the Internet phone caller and the notification system will call the Internet phone caller through Internet phone system and bridges it to the previous call party.

### DRAWING FIGURES

A system and method for a phone device to receiving notice from a notification system and perform one or more tasks. In the following description, for purpose of explanation, numerous of specific details are set forth in order to provide a thorough understanding of the present invention.

FIG. 1 shows an embodiment of the present invention that a host system is computer system and is linked with a phone dialer system.

FIG. 2 shows an embodiment of the present invention that a user's phone device.

FIG. 3 shows the relation between trigger condition, source phone group, and destination phone group.

FIG. 4 shows the operation flow of the notification system.

FIG. 5 shows the operation flow of the monitor system on user's phone.

FIG. 6 shows the work flow of the monitor system that works independently from the notification system.

### DESCRIPTION—FIGS. 1 TO 6

FIG. 1 illustrates an example of a notification system 0100 for detecting and notifying trigger events in accordance with some embodiments of the present invention. The computer system 0100 is generally implemented using any conventional general-purpose computer having conventional computer components, including at least one processor 0101, program memory 0102, network interface 0103, and one or more input or output devices 0104. The input device may include mouse, keyboard, touch sensitive screen, or voice recognition module. The output device may include monitor, screen, or speaker module. Application program 0105 is generally executed on top of any conventional operating system 0106. Application program 0105 is generally programmed in any conventional general-purpose programming language, such as Java, C, and C++, any combination of general-purpose programming languages, or any combination of a general-purpose programming language and a more specialized programming language, such as a scripting language (Perl). In general, any computing device capable of processing information may be used in various embodiments of the present invention. Computer system 0100 links to a database 0107 storing one or more trigger conditions. A telephone dialer 0108 is link to computer system 0100 and is able to make phone call from multiple phone originations.

The notification system receives signal or message from applications, the network interface 0103, or input/output devices 0104. The notification receives at least one user's trigger condition and returns a phone group to user. One or more phone identities in the phone group are used to call said user at the event that matches with the trigger condition.

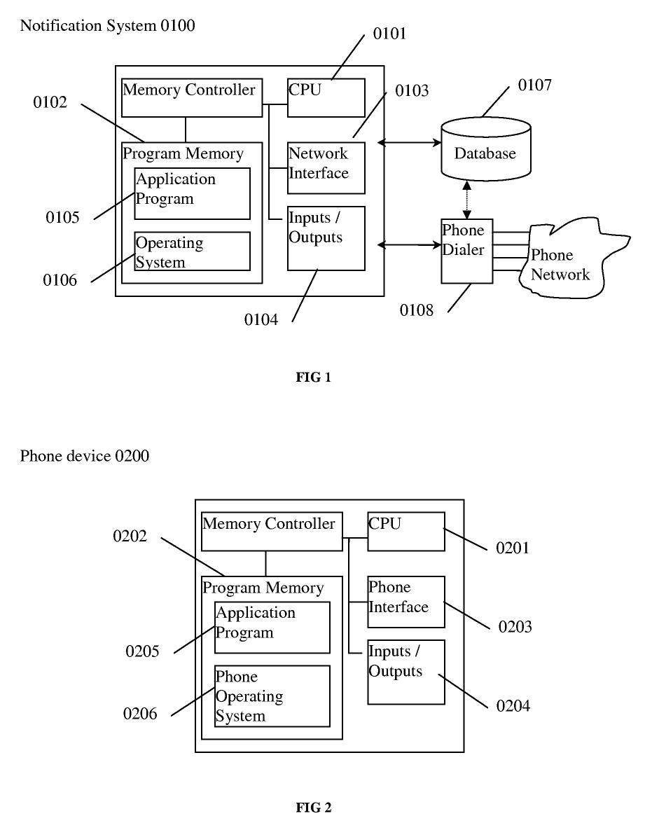

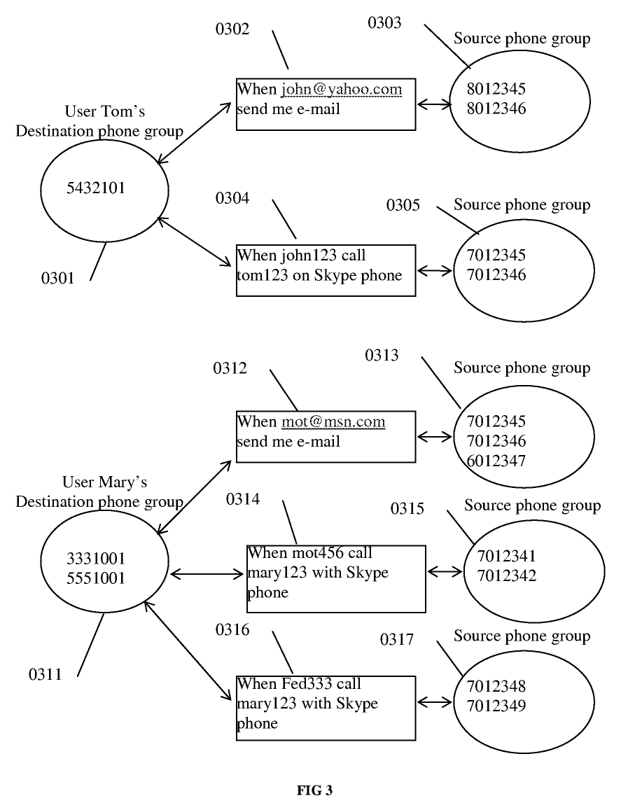

In the present invention, the phone device to receive notification by telephone call can be any telephone phone, for example a mobile phone manufactured by Nokia Inc etc. FIG. 2 shows the example of the phone device of an embodiment. The phone device 0200 is generally implemented using any conventional phone having conventional phone components, including at least one processor 0201, program memory 0202, phone communication interface 0203 for connecting to phone network, and one or more input or output devices 0204. Application program 0205 is general executed on top of operating system 0206 by the processor 0201. In another embodiment, phone device is a smarter phone, for example SmartPhone or PocketPC Phone developed by Microsoft Corporation of Redmond, which usually has dual processors, one for phone communication stack and one for general PDA application. It might further include other communication interface, such as Bluetooth or WiFi.

In one embodiment, user uses web browser on a desktop computer to login to Web server on notification system 0100 through Internet. Notification system determines user's identity through the login process. The Web server displays a trigger condition creation Web page with multiple trigger condition options for user to choose, for example new e-mail arrival, stock price at new highs and lows, or the score of a sport event. User is allowed to specify more detail conditions, for example the e-mail sender must be john@yahoo.com. User further specifies a group of destination phone number for the notification system to call upon the trigger event occurred. The Web site certainly can provide a tool for user to specify user's own trigger condition instead of the pre-formatted trigger condition. When user selects OK on the creation page, system 10 stores the trigger condition in the database 0107 and associates the trigger condition with the destination phone group and further associates with a source phone group. Said each phone group might contain one or more phone identities, such as numbers or Caller IDs. Depending on the phone system, a Caller ID might contain the phone number part and the name part, and either part can be used to identify phone origination in the phone groups. The selection of source phone group might be based on the area code of the phone number in the destination phone group, the source phone group of user's other trigger condition, or further based on the load balancing decision, which is to balance the number of trigger conditions assigned to each source phone number or the possibility of occurrence. Upon the trigger event that matches with the trigger condition, notification system instructs a phone dialer to make phone call from a phone number in the source phone group to a phone number in the destination phone group. The notification certainly can try to call more or all phone number in the destination phone group. In this embodiment, a mapping module of the notification system automatically assigns the source phone number to each of trigger conditions. However, user might be allowed to choose the source phone from a pool of phone numbers in other embodiment. In an alternative embodiment, user might use web browser on a smart phone to connect to the Web server through wireless data communication network instead of using the desktop computer. In yet another embodiment, user might use a customized application program, instead of web browser, on a PocketPC phone to setup the trigger conditions through wireless data communication network.

FIG. 3 shows the relation between trigger conditions, source phone numbers, and destination phone numbers. User Tom's mobile 5432101 is selected as the destination phone group 0301 and Tom registers two trigger conditions 0302 and 0304 with notification system. Trigger condition 0302 is triggered when Tom received e-mail from john@yahoo.com, and is assigned to source phone group 0303, which includes phone number 8012345 and 8012346. Trigger condition 0304 is triggered when john123 call tom123, Tom's identity, on Skype Phone, and is assigned to source phone group 0305, which includes phone number 7012345 and 7012346. When Tom received incoming phone call from 7012345, he know john123 is calling him on Skype Phone. Similarly, User Mary registers three trigger conditions, 0312, 0314, and 0316. The source phone groups for each trigger condition of a user are preferably to be distinct form each other. Mary has mobile phone 3331001 and home phone 5551001; both phones are selected as destination phone group 0311 with higher priority for mobile phone. For example in the event that mot456 call mary123, Mary's identity, on Skype Phone, one phone number in source group and 3331001 in destination group are selected by the notification system and deliver to the phone dialer 0108. Then, the dialer makes a phone call from selected source phone number to selected destination phone number. If the selected destination phone number is busy, another destination phone number from the destination group is selected. In another embodiment, the phone dialer 0108 retrieves the source phone number and destination phone number from database 0107 directly by given an identifier of the trigger condition that is provided by the notification system.

After notification system successfully registering a trigger condition, the notification system returns the group of source phone number or caller ID back to user through a Web page or directly to the customized program on user's phone. If multiple trigger conditions are registered, the mapping between trigger conditions and source phone groups is returned to user. Then, user can assign a special ring tone for the incoming call from one or more of the source phone numbers on user's phone device. In another embodiment, user might schedule a job on user's phone for replaying a pre-recorded audio message upon detecting an incoming call from one of said source phone groups, for example said “You got mail from John” when incoming call from 80112345 or 80112346 in FIG. 3. The user might schedule another job to bring up e-mail client and automatically connect to the e-mail server for exchanging e-mails. In yet another embodiment said customized program on user's phone automatically associates the received one or more source phone numbers with a special ring tone or picture, or automatically schedules a particular job upon receiving call from one of said source phone number. The job, for example, includes sending out a remind message, sending/receiving e-mail, downloading information, sending out control instruction to other devices, such as computers or appliances, etc.

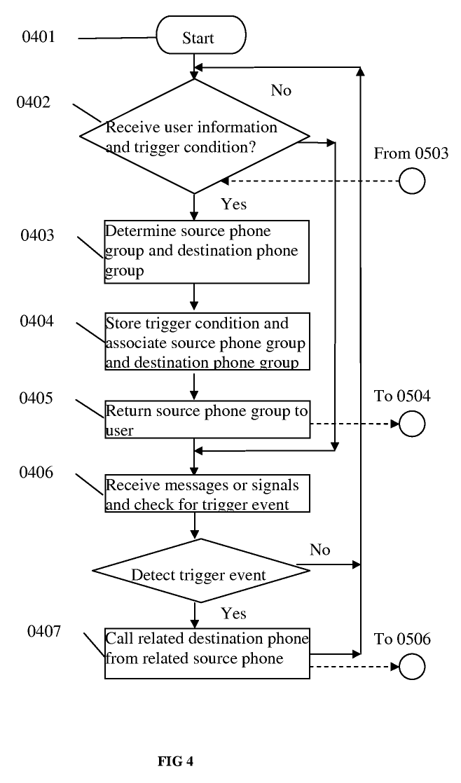

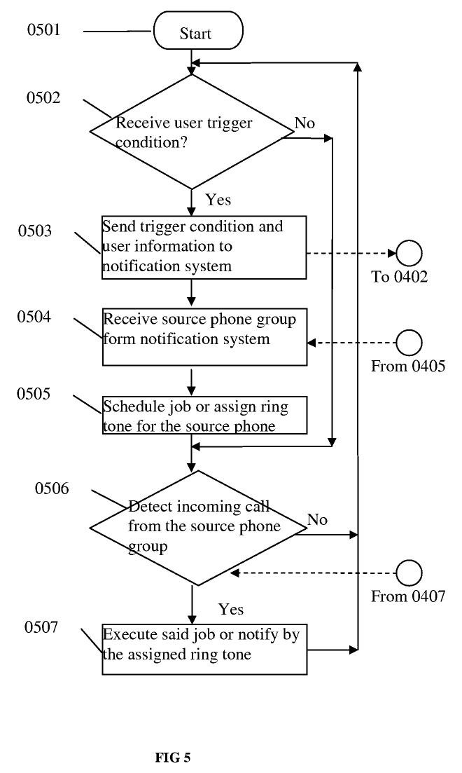

FIG. 4 shows the operation flow of the notification system. In step 0401, the notification system starts. In step 0402, go to 0403 if receive trigger condition and user information for determining the source phone group. Otherwise, go to 0406. Said user information can be one or more user's phone numbers or a user identity for looking up user's phone number in a contact database. In step 0403, determine a source phone group. The determination might be based on the area code of the destination phone number, the source phone group of said user's other trigger condition, or the load on each individual source phone. In step 0404, stores the trigger condition in database 0107, and associates the trigger condition with the destination phone group and the source phone group. The destination phone group includes said one or more user's phone numbers. In step 0405, return the source phone group to user. In another embodiment, the trigger condition or its identity might be further returned. In yet another embodiment, an expiration condition will be further given to the association between the trigger condition and it source phone group by either the notification system or user and agrees by both parties. The expiration condition might be a expiration time or the number of reoccurrence of a trigger event. If said association expires, the association will be automatically terminated or removed from the notification system and the user's phone, and the source phone group can be reuse for other trigger conditions. In step 0406, receive messages or signals, and check for trigger condition. If the received message or signals match with the trigger condition, go to step 0407, instruct the phone dialer 0108 to call a destination phone number from a source phone number that associate with said trigger condition, and then go back to step 0402. If received message or signals doesn't match with the trigger condition, go back to step 0402.

FIG. 5 shows the operation flow of user's phone device. In step 0501, the monitor system starts on user's phone device. In step 0502, receive a trigger condition from user. In step 0503, send the trigger condition to the notification system 0100, which is coupled to step 0402 in FIG. 4. In step 0504, receive the source phone group from notification system, which is coupled with step 0405 in FIG. 4. In step 0505, schedule a job on phone device or associate a special ring tone or picture with one or more phone numbers in the received source phone group. Said job can be a default function or specified by the user. In step 0506, detect incoming phone call from said source phone group. In step 0507, execute the job if an incoming call is from said source phone group, which is coupled with step 0407 in FIG. 4, and then go back to step 0502. The step 0502, 0503, 0504, and 0505 can be executed in a separate thread that is well known in the computer programming art.

In an embodiment, user would like to receive the phone call from an important Internet phone caller. The Internet phone, for example Skype manufactured by Skype Limited, runs on a desktop computer. However, user is away from the desktop computer. User schedules a trigger condition with said notification system 0100 for notifying said user upon said important Internet phone caller calls said user through the Internet phone. To register Internet phone callers, the user sends the notification system one or more Internet phone caller identities and a user information for determining the destination phone group. The user information is either the user's one or more phone numbers or user's identity for determining user's phone. The mapping module of the notification system of the present embodiment associates each of said Internet phone caller identities to a source phone group. The mapping between Internet phone caller identity and source phone group is stored in database 0107 and is returned to the user. The relation between the phone number or caller ID in source phone group and the identity of the Internet phone caller can be added into the contact list in user's phone by user manually or by a program automatically. User can incrementally add new phone caller to notification system. The notification system preferably assigns the new phone caller a new source phone group that is different from the source phone group for user's existing phone caller. The notification system detects the event that one of the registered Internet phone caller calls the user through Internet phone. There are many way to signal notification system, for example plug in a program into user's Internet phone to send notification system the caller identity when receiving an incoming call or have the notification system login the Internet phone system as said user, wherein the notification system will know who is calling the user. By knowing the identity of Internet phone caller and identity of the user, the notification system then retrieves the related source phone group and destination phone group from database 0107 and instructs phone dialer 0108 to call one or more phones in the destination phone group from one or more phones in the source phone number. When user's phone received call from a phone in the source phone group, user's phone shows the phone number, or caller ID, of the incoming call and the present invention will further shows the identity of the Internet phone caller. User can either ignore the phone call or answer the phone call. If user answers the phone call, the dialer automatically bridges the Internet phone caller and the user. If user miss the phone call and later dial back to the source phone number, the notification system can derive the identity of latest Internet phone caller from the user's phone number or caller ID, and then call the Internet phone caller through the Internet phone, and bridge the Internet phone caller and the user. Since said each of user's Internet phone caller is associated with a distinct group of source phone number, the user can tell the identity of the Internet phone caller by looking at the incoming call phone number, caller ID, or the Internet phone caller identity. In another embodiment, when registering the identity of Internet phone caller, notification system can automatically generate a contact list that associates the phone number in source phone group to the related Internet phone caller identity. The contact list can then be sent to user's phone and appended to the contact list in the phone. In yet another embodiment, the notification system further provides user a call back phone number for each Internet phone caller. User can call (or call back) an Internet phone caller by calling the related call back phone number. The notification system can derived the identity of the Internet phone caller from the call back phone number and the incoming call phone number or caller ID, which identifies the user. The notification system further calls the Internet phone caller through the Internet phone system, and bridges the user and the Internet phone caller. If several user's Internet phone callers share the same call back phone number, the user will be bridge to most recent unsuccessful Internet phone caller. The present application basically provides a solution to map the first group of caller identity to the second group of caller identity. Two groups might pertain to the same phone system or to different phone systems, for example one is PSTN system and one is VoIP system. This application allows user or user's phone to derive the caller's identity in the second group from the identity of the incoming phone in the first group.

In another embodiment, the notification system does not have enough outgoing phone lines and some of the Internet phone callers need to share the same source phone group. The present embodiment can further assign these shared Internet phone callers to different time slots. For example, notify user at the first quarter of a minute when caller A calls and notify user at the second quarter of a minute when caller B calls. This embodiment uses less phone resource but might have some delay for waiting for the correct time slot.

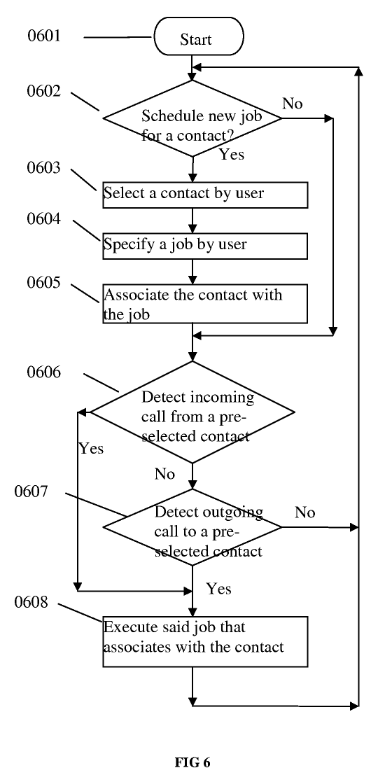

Although the monitor system on user's phone is tightly integrated with the notification system, the monitor system can also be used independently. User can schedule a job to be executed upon an incoming call from a particular contact, caller, or phone number, which does not necessary the phone number selected by the notification system. In one embodiment, user schedules a reminder that is associated with a contact, caller, or phone number. In addition to the ring tone or a picture that identifies the caller of an incoming call, the monitor system further presents the reminder message to user upon receiving a call from said contact, caller, or phone number. Since incoming caller's phone number or caller ID already tell user who the caller is, said reminder of the present invention is for reminding user extra information in addition to who the caller is. In the preferred embodiment, said extra information might be related to one or more selected from an event, a time, a place, a thing, or another contact. For example in Microsoft Outlook, a contact can be associated with information related to an event in the calendar, a task in to-do list, an e-mail in e-mail box, a note, a entry in journal, or another contact, etc. In another embodiment, user schedules a job to open a document by a document reader. For example, user's boss might call user for a discussion and user would like to tell his boss a research summary in a spreadsheet. The user can schedule a job to open the spreadsheet document upon user's boss call the user. Alternatively, the monitor system can monitor the outgoing call. The monitor system can automatically perform a scheduled job when user is calling a phone number or person that associated with said job. For example, user select a contact from the contact list in his phone and input a reminder message “Ask pick up time” for associating with the contact. When user initiate a call to the contact, the monitor system detects the outgoing call and retrieves the reminder message associated with said contact and executes a default job that presents said reminder message to the user. The way to present a reminder is well known in the art, for example presenting in text, picture, audio, video, etc. If the contact calls the user first, the monitor system identify the contact according to the phone number or caller ID of the incoming call, retrieve the associated information, and present the information to the user. So, in either case, the user will be reminded to ask the other call party the pick up time. FIG. 6 shows the work flow of the monitor system that works independently from the notification system. The monitor system starts from step 0601. In step 0602, go to 0603 if user would like to schedule a new job, otherwise, go to step 0606. In step 0603, user selects a contact. A contact usually is related to a person or a business and includes a phone number, a name, or a picture that identifies the contact. In step 0604, user specifies a job. Said job might include one or more tasks and the related information. For scheduling a default reminder job, user might only need to specify the reminder message. In step 0605, associate the job with the contact. In step 0606, go to step 0608 if detect an incoming call from the selected contact, otherwise, go to step 0607. In step 0607, go to step 0608 if detect an outgoing call to said contact, otherwise, go to step 0602. During scheduling the job, user can specify the expired date/time or the number of recurrence of the job execution, for example, once, twice, always, etc. Said expired date/time and the number of recurrence can be stored in memory. The job can be automatically removed after expired or satisfied the number of recurrence or removed with user's confirmation. This reminder or job triggering method can be used either in the traditional phone or the Internet phone. The contact, the job related information, or their association can be stored either in the phone or in a remote computer system and retrieved on demand. Separating FIG. 6 from FIG. 5 is just for easy of explanation. Merge FIG. 6 flow with FIG. 5 flow is just a practice of computer programming and well know in the art.

### CONCLUSION, RAMIFICATIONS, AND SCOPE

The present invention provides a notification system that calls user's phone from a pre-selected phone that associates with a trigger conditions upon detects the trigger event of said trigger conditions. On user's phone, the present invention further provides a monitor system that triggers a pre-selected job upon detecting an incoming call from or outgoing call to a pre-selected contact according to phone number or Caller ID.

Although the description above contains many specific details, these should not be construed as limiting the scope of the invention but as merely providing illustrations of some the possible embodiments of the invention.

Thus, the scope of the invention should be determined by the appended claims and their legal equivalents, rather than by the examples given.

I claim:

1. A method for notifying a user's phone, the method comprising:
registering multiple trigger conditions;
associating said multiple trigger conditions with said user's phone;
assigning each said trigger condition a phone group, wherein said phone group includes one or more phone originations;
outputting the mapping relationship between said multiple trigger conditions and their phone groups;
detecting at least one trigger event that matches with one of said multiple trigger conditions; and
making a phone call from the phone origination in the phone group of the trigger condition of said trigger event to said user's phone in response to the detection of said trigger event.

2. The method of claim 1, wherein each said trigger condition is assigned a unique phone group within said multiple trigger conditions.

3. The method of claim 1, further comprising disconnecting said phone call before said user answers said phone call.

4. The method of claim 1, further comprising disconnecting said phone call after a period of time selected by said user.

5. The method of claim 1, further comprising disconnecting said phone call after receiving a number of ring tone determined by said user.

6. The method of claim 1, wherein the association between a trigger condition and its source phone group can be removed according to an expiration condition.

7. A notification system for notifying a user's phone, the system comprising:
a phone dialer, wherein said phone dialer can initiate call from multiple phone originations;
a trigger condition database, wherein said user's phone associates with multiple trigger conditions in said database;
a mapping module that assigns each of said multiple trigger conditions a phone group, wherein said phone group includes on or more phones selected from said multiple phone originations;
an output of the mapping relationship between said multiple trigger conditions and their phone groups;
a detector for detecting the trigger event that matches with one of said trigger conditions; and
a link for said detector to instruct said phone dialer to call said user's phone from at least one phone origination in said phone group that is associated with the trigger condition of said trigger event.

8. The system of claim 7, wherein each said trigger condition is assigned a unique phone group within said multiple trigger conditions.

9. The system of claim 7, wherein said phone dialer disconnects said phone call before said user answers said phone call.

10. The system of claim 7, further comprising disconnecting said phone call after a period of time selected by said user.

11. The system of claim 7, further comprising disconnecting said phone call after receiving a number of ring tone determined by said user.

12. The system of claim 7, wherein the association between a trigger condition and its source phone group can be terminated according to an expiration condition.
